(19) United States
(12) Patent Application Publication
(10) Pub. No.: US 2016/0063050 A1
(43) Pub. Date: Mar. 3, 2016

(54) Database Migration Consistency Checker

(71) Applicants: Joerg Schoen, Nusslock (DE); Volker Driesen, Walldorf (DE)

(72) Inventors: Joerg Schoen, Nusslock (DE); Volker Driesen, Walldorf (DE)

(21) Appl. No.: 14/471,527

(22) Filed: Aug. 28, 2014

(51) Int. Cl. G06F 17/30

(52) U.S. Cl. CPC G06F 17/30371; G06F 17/30312

(57) ABSTRACT

Following migration of data from one database to another, the contents of the source and target databases may be checked for consistency based on checksums computed for corresponding portions of the two databases. The origin of discrepancies may be determined iteratively by computing checksums for increasingly smaller sub-portions of portions whose checksums do not match.

### TECHNICAL FIELD

This document relates generally to database migration, and more particularly to tools and methods for checking the source and target databases for consistency following a migration.

### BACKGROUND

Many enterprises and other organizations nowadays store vast amounts of data in databases, often using commercially available database platforms and associated data analytics tools provided by third-party vendors. Sometimes, the need or desire arises to migrate data from one database to another, for example, in order to switch vendors, take advantage of newly available database functionality, or transition to a different hardware platform or operating system. Exporting the data from the old database (the “source”) and importing it into the new database (the “target”) can be a complex and time-consuming process (e.g., requiring several hours or even days, depending on the size of the databases). To minimize disruptions to the organization resulting from system downtime, the migration procedure is therefore desirably optimized for short duration.

Data migration is susceptible to errors resulting in data loss or inconsistencies. For example, if the available database objects (such as tables, indexes, and views) differ between the source and target database types, one or more unsupported tables or indexes may be missing from the target database. Systematic discrepancies may arise if the table structure is not consistent between the source and target database types. Further, table contents (e.g., rows, columns, or individual fields) can get lost or corrupted. The problems can be exacerbated, and the likelihood of their occurrence increased, if the migration involves splitting, clustering, or de-clustering of tables, conversions between different character sets (e.g., from UTF8 to UNICODE), etc. To avoid deploying (or “going live” with) a corrupted database, which can have severe consequences in particular with certain types of sensitive or mission-critical data (e.g., financial data), it is therefore desirable to first check the source and target databases for consistency. This check itself, however, can cost valuable time, increasing the overall cost of the migration project.

### BRIEF DESCRIPTION OF DRAWINGS

The present disclosure illustrates embodiments of the inventive subject matter by way of example and not limitation, and with reference to the following drawings:

FIG. 1 depicts a database consistency checker tool in accordance with some embodiments.

FIG. 2 is a flow chart illustrating a method for checking database consistency in accordance with some embodiments.

FIGS. 3A-3D illustrate example contents of checksum files generated in the course of checking database consistency in accordance with some embodiments.

FIG. 4 depicts a software-update and database-migration system with integrated consistency-checking functionality in accordance with some embodiments.

FIG. 5 is a block diagram illustrating an example of a software architecture that may be installed on a machine, according to example embodiments.

FIG. 6 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. For the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

Disclosed herein are computational methods and tools (e.g., implemented in hardware and/or software) for checking the consistency between a source database and a target database following database migration. Database migration, as used herein, refers generally to the copying or transfer of data from one database to another in a manner that preserves the data contents themselves while allowing the data to be structured and/or represented differently. That it is designed to preserve the data contents does not, of course, mean that the transfer is perfect, i.e., without loss or corruption of any data; in fact, the tools and methods described herein serve to detect and localize any discrepancies resulting from deficiencies in the migration.

In various embodiments, the consistency check involves computing checksums for corresponding portions of the two databases and comparing these checksums. The portions may initially be large; for instance, for databases including on the order of a million entries, each portion may include 10,000 database entries (with an exception for the last portion, which may include however many entries are left). A discrepancy between the checksum computed for a portion of the source database and the checksum computed for a corresponding portion (e.g., a portion covering the same key range of database entries) of the target database indicates that data from that portion got lost or corrupted during the migration. Once such a discrepancy has been detected, the portion at issue may be subdivided into smaller portions (e.g., sub-portions of only 100 entries each), and the checksum computation and comparison may be repeated for the smaller portions to better localize the data inconsistency. The entire process may be repeated iteratively until the portion size is reduced to a single database entry, or such other pre-defined level of granularity as is desired.

In various embodiments, the iterative approach of computing checksums initially for large portions of the databases and drilling down to smaller and smaller portions only if and where discrepancies occur renders consistency checking in accordance herewith very fast, compared with, e.g., methods that involve direct comparisons between all database entries. For example, in some embodiments, source and target databases containing each about one Terabyte of data can be checked for consistency in less than two hours (using enterprise servers with parallelization). At the same time, the database consistency checks in accordance herewith provide a reliable indication of whether a database migration was successful, since they usually involve comparing (via the checksums) all data between the source and target databases, not merely data samples. Thus, if a complete consistency check is performed without revealing any checksum discrepancy, it is highly unlikely that data was lost or corrupted during the migration.

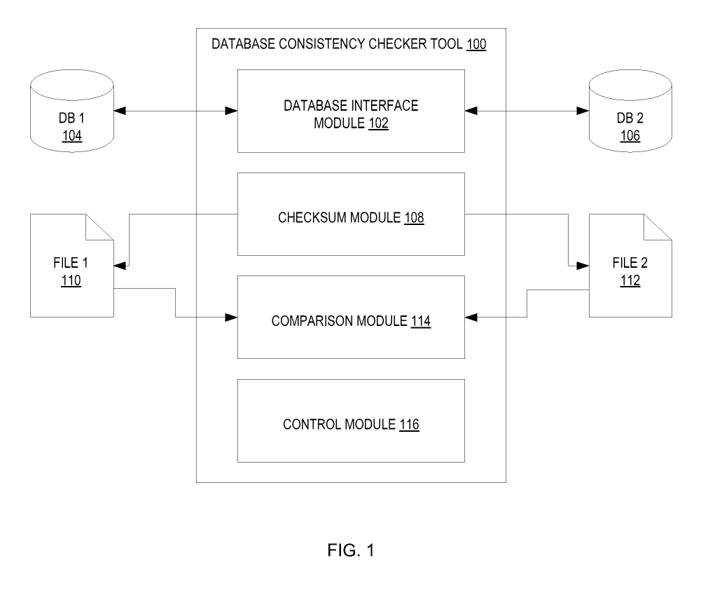

FIG. 1 illustrates, in block-diagram form, an example consistency checker tool 100 in accordance with various embodiments. The tool 100 may include a number of modules implementing certain functionalities within the overall checking process. It should be understood, however, that the depicted organization into modules is merely an illustrative example, and that the functionalities can be grouped in different ways and divided into more or integrated into fewer modules. Furthermore, it will be appreciated by those of ordinary skill in the art that the various modules can be implemented as software modules executed, e.g., on a general-purpose computer, as pure hardware modules (e.g., hardwired circuits), or as some other combination of hardware, firmware, and software, such as using a plurality of (optionally programmable) special-purpose processors.

As shown, the database consistency checker tool 100 includes a database interface module 102 that can read in, i.e., import data from, the source database 104 (DB 1) and target database 106 (DB 2) or portions thereof (e.g., individual tables within the databases 104, 106). The databases 104, 106 may (but need not) be stored on different hosts (i.e., different computers or computer systems), may (but need not) be running on different operations systems, and may (but need not) be products from different vendors. In situations where the data is represented or formatted differently in the two databases 104, 106, the database interface module 102 may act as a bridge between the different representations by converting them into a common format (which may involve converting data from either one or from both databases 104, 106). For example, in some embodiments, the database interface module 102 maps native database types to data types conforming to the Advanced Business Application Programming (ABAP) language created by SAP SE (Walldorf, Germany).

The database consistency checker tool 100 further includes a checksum module 108 that receives database portions from the database interface module 102 and computes a checksum for each such portion. A checksum (also sometimes referred to as a “hash sum”) is a small datum, typically an integer number, computed from an arbitrary block of (digital) data using a function or algorithm (the “checksum algorithm”) that generally results in significantly different output values for different (even only minimally different) input data blocks. A large number of checksum algorithms are known to persons of ordinary skill in the art; examples include, without limitation, longitudinal parity check, modular sum, position-dependent checksums (e.g., cyclic redundancy checks (e.g., resulting in 32-bit checksums), Fletcher's checksum, Adler-32), and MD5 (a cryptographic hash function producing a 128-bit hash value). In general, the higher the number of bits used in the checksum, the lower is the risk of failing to detect an error. The checksum module 108 may generally utilize any suitable checksum algorithm, though some algorithms may be preferable over others, depending on their performance parameters and the circumstances. For example, simpler, faster algorithms may be used when the cost of any system down-time is high, whereas more complex algorithms with fewer possible false negatives (i.e., checksums failing to reflect a change to the input data) may be used with mission-critical data. To facilitate comparisons between data that is structured differently in the source and target databases 104, 106, the checksum module 108 may be configured to skip over certain fields within the database entries when computing the checksums.

The checksum module 108 may store the checksums, along with information identifying the database portions for which they were computed, in one or more files for each of the source and target databases 104, 106. For example, as illustrated, the checksums computed from portions of the source database DB 1 (104) may be stored in File 1 (110), and the checksums computed from corresponding portions of the target database DB 2 (106) may be stored in a separate File 2 (112). Of course, the checksums for DB 1 may also be recorded in multiple files, as long as each checksum file can be clearly associated with the database portions whose checksums it includes. Similarly, the checksums for DB2 may be recorded in multiple files (and, typically, the distribution of checksums over multiple files follows the same pattern for DB 1 and DB 2 to facilitate comparisons between the files). Multiple files may be useful, for instance, if the databases 104, 106 each include multiple tables; in this case, a separate checksum file may be created for each table within each database.

The database consistency checker tool 100 further includes a comparison module 114 that reads in the checksum files 110, 112 and compares the checksums for corresponding database portions of the source and target databases 104, 106. Any discrepancies may be written to an output file, displayed on the screen to alert a system administrator, and/or communicated to the other components of the tool 100, e.g., to trigger the next step of the iterative procedure.

The operational flow and interactions between the various modules of the consistency checker tool 100 may be controlled by a control module 116. The control module 116 may, for instance, be responsible for determining the size of the database portions, e.g., based on the size of the databases 104, 106 and using human input or pre-programmed logic regarding the desirable number of sub-divisions of the databases 104, 106 or the desired number of entries in each portion, and for signaling the determined portion size to the database interface module 102. The control module 116 may also initiate the next iteration of checksum computations and comparisons upon detection of a discrepancy by the comparison module 114, and compute the reduced database portion size for that iteration (e.g., based on the previous portions' size). Under certain circumstances, e.g., if the number of discrepancies identified by the comparison module 114 in a particular iteration exceeds a pre-defined threshold, indicating a systematic problem with the database migration that warrants starting over, the control module 116 may abort the consistency check.

Further, the control module 116 may be responsible for implementing a certain order of operations. In some embodiments, the database interface module 102 can fetch database portions, and the checksum module 108 can compute their respective checksums, in parallel for the source and target databases 104, 106. In other embodiments, the retrieval and checksum computation for the source database 104 is completed (for a given iteration) before the database interface module 102 identifies and retrieves corresponding portions of the target database 106. Furthermore, in some embodiments, the database interface module 102, checksum module 108, and comparison module 114 perform their respective functions partially in parallel, e.g., in a pipelined scheme in which the checksum module 108 can start computing checksums as soon as one or more database portions have been fetched by the database interface module 102, and in which the comparison module 114 can read data from checksum files 110, 112 before all the checksums have been computed for the current iteration. In other embodiments, the database interface module 102, checksum module 108, and comparison module 114 operate sequentially, each waiting for the preceding module to complete its task.

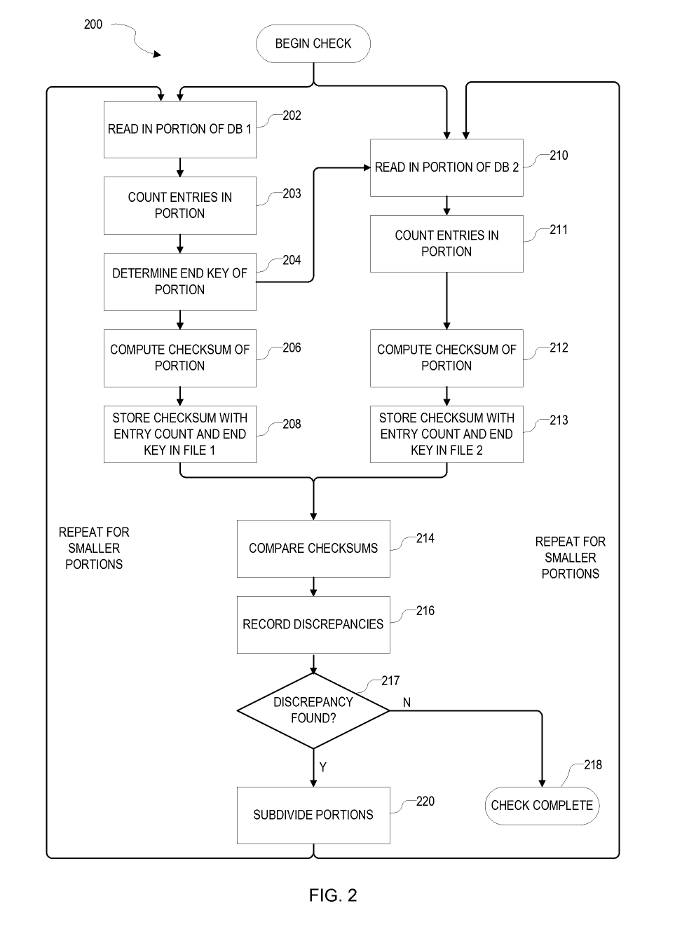

FIG. 2 illustrates, in the form of a flow chart, an example method 200 for checking database consistency in accordance with various embodiments. The method 200 usually involves multiple iterations (unless, of course, no discrepancy is detected during the first iteration) in which checksums are computed for successively smaller database portions of a specified size. Each iteration begins by reading in (e.g., loading into memory allocated to consistency checker tool 100) one or more portions of the specified size from the source database (operation 202). The portion may be specified in terms of the number of entries contained therein (an entry corresponding, e.g., to one row of the database table). (The terms “row” and “entry” are hereinafter used synonymously.) Thus, if the initial portion size is 10,000 rows, the tool 100 may fetch the first 10,000 rows from the source database 104. These first 10,000 rows have an associated range of keys (a key being a unique identifier of a database entry). For example, for a database storing customer information (each customer having exactly one entry), the customer's name may serve as the key. The key may have two or more parts, e.g., a last name followed by a first name. The first 10,000 entries may correspond to all customers with names, within an alphabetically ordered listing, between, for instance, “Adams, Allen” and “Cole, Synthia;” the next 10,000 entries of the database may then go, for instance, from “Cole, Timothy” to “Erhard, David,” and so on. The consistency checker tool 100 (e.g., with its database interface module 102) may (optionally) count the entries of the retrieved database portion (operation 203) (e.g., to confirm that a portion of the proper size was fetched), and determine the associated end key of the range (operation 204). The checksum module 108 may compute the checksum for the retrieved portion (operation 206) and store it in a checksum file (File 1) 110 (operation 208), along with the associated row count (e.g., 10,000 in the first iteration) and end key. This procedure may be repeated until checksums have been computed for the entire database 104, or an entire table within the database 104 containing multiple tables.

After or temporally overlapping with the creation of the checksum file for the source database 104, checksums may similarly be determined for the target database 106. This involves, first, retrieving portions from the target database 106 that correspond to (or are assumed to correspond to) the portions of the source database 104 (operation 210). In some embodiments, the database interface module 102 simply retrieves portions of the specified size (e.g., 10,000 rows) from the target database 106. If any rows were lost during the migration, this will, of course, result in discrepancies that can readily be detected based on the comparison of the checksums. In other embodiments, the database interface module 102 reads in portions from the target database 106 based on the end keys associated with the portions of the source database 104 and stored in the first checksum file (File 1 110). The number of rows in these portions may be counted (operation 211), providing a means to check that no rows got lost that is independent from the checksum computation. The checksum module 108 may then compute the checksum for the respective portion of the target database 106 (operation 212) and store the checksum, along with the row count and end key, in a checksum file (File 2) 112 for the target database 106 (operation 213). The procedure may be repeated until checksums have been computed for the entire database 106, or an entire table within a database 106 containing multiple tables.

Once checksum files 110, 112 have been created for both source and target databases 104, 106, the contents of these files may be compared (operation 214), e.g., row by row, and any discrepancies between pairs of corresponding checksums (one from the source checksum File 1 110 and one from the target checksum File 2 112) may be recorded (operation 216), e.g., written to an output file. If checksums for the whole databases 104, 106 have been compared in their entireties and no discrepancies have been found (at operation 217), the consistency check is complete (operation 218). Otherwise, if one or more database portions differ between the source and target databases 104, 106, as reflected in different checksums for two portions that should correspond to one another, the consistency checker tool 100 may drill deeper by subdividing database portions (operation 220) and repeating the whole process for the smaller portion size. Subdivision may be accomplished by reducing the number of entries per database (sub-)portion to a specified smaller number (e.g., 100 rows), or to a specified fraction of the size of the (parent) portions (e.g., to 1/10 or 1/100). For example, if each database portion in the first iteration included 10,000 rows and the division reduces the portion size by a factor of 100, the second iteration will involve retrieving, and computing checksums for, portions including only 100 rows each. The iterations may continue until the portion size has achieved a certain minimum size (and the origin of the discrepancy is thereby localized in a portion of such minimum size), corresponding to a desired level of granularity of the consistency check. In some embodiments, iterations continue until missing or corrupted data has been localized down to the individual database entry.

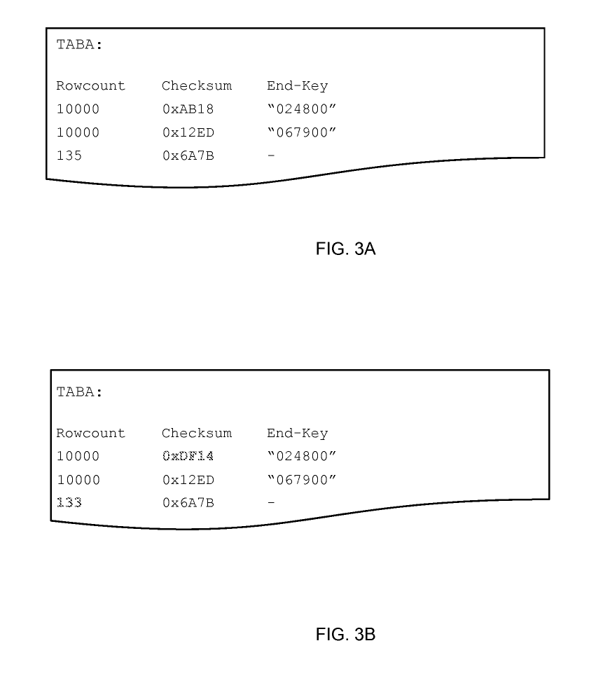

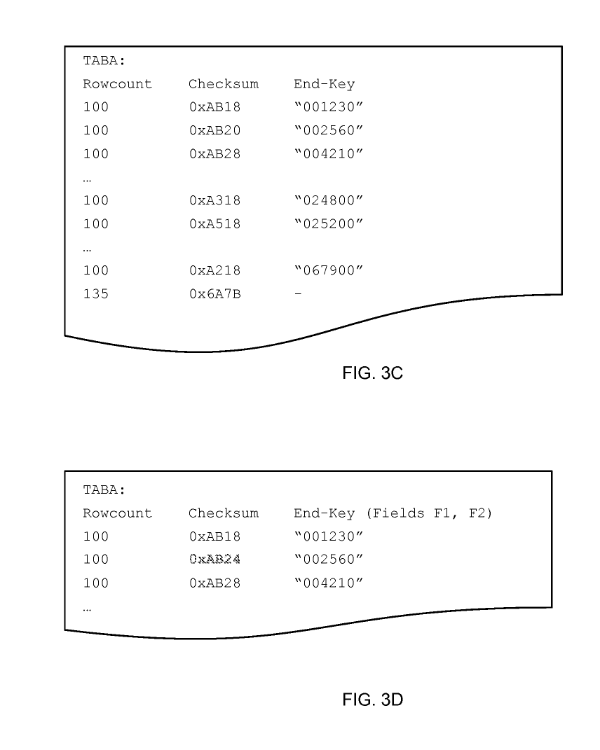

FIGS. 3A-3D illustrate exemplary checksum files for two iterations during a database consistency check. The file depicted in FIG. 3A records data for Table A of the source database (e.g., database 104) during the first iteration, including, for each portion of the database, the number of rows (10,000 in the example shown, except for the last portion, which includes fewer rows (e.g., 135)), the checksum (expressed as a hexadecimal number), and the end key, i.e., the key of the last database entry within a given portion. (While the end key is illustrated herein, for simplicity, as a single number, multiple-valued keys may also be used in some embodiments, e.g., corresponding to a person's first name and last name.) FIG. 3B shows the target checksum file for Table A for the first iteration. Absent any data corruption during the migration, this file should look the same as the source checksum file of FIG. 3A. However, as a close comparison reveals, the checksums for the first database portion, corresponding to the key range ending with “024800”, differ between the source and target checksum files. Furthermore, the row count for the last portion of Table A from the target database is lower than that for the last portion of Table A from the source database. Accordingly, consistency checking has proceeded to the second iteration.

FIG. 3C illustrates the source checksum file for Table A for the second iteration. As the row count indicates, the portions have been divided into sub-portions including only 100 rows each. FIG. 3D shows the corresponding target checksum file for Table A for the second iteration. By comparison between these two files, the range in which the migration error occurred can be further narrowed down to the second sub-portion (e.g., rows 101 to 200), corresponding to the key range ending in “002560.” This range may be analyzed further in the third iteration.

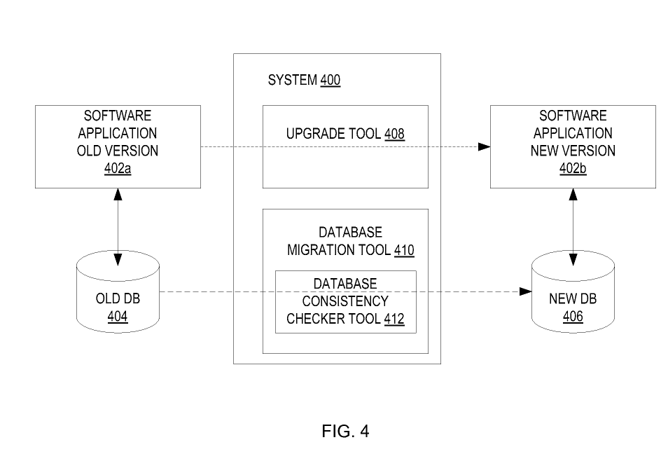

The consistency checker tool 100 may be implemented as a stand-alone tool, or integrated with other tools that facilitate database migration and related system and software updates or upgrades. FIG. 4 illustrates an embodiments of such an integrated system 400 in the context of an example use case: the update or upgrade of a software application from an old version 402a to a new version 402b, which may entail the need to also transition from an old database 404 to a new database 406, e.g., because of an incompatibility of the new application version 402b with the old database 404. For instance, the new application version 402b may provide enhanced data analytics functionality that relies on a certain way of structuring the underlying database. The software vendor may offer a database product that meets the requirements, and encourage its customers to switch to that database. To ease the transition, the vendor may also provide a system 400 (e.g., a software update management program executable on the same computer system where the software application 402a and/or 402b is already running) that orchestrates both the software application upgrade (e.g., using an upgrade tool 408) and the database migration (e.g., using a database migration tool 410). The migration tool 410 may read data in from the old database 404 and write the data to the new database 406, optionally after performing certain transformations, such as, e.g., converting data between different character sets or data types, compressing or de-compressing data, or splitting a large table into multiple smaller tables (e.g., to facilitate parallelizing the migration). In some embodiments, the migration tool 410 includes functionality for automatically splitting databases into multiple tables or portions that can be transferred in parallel; migration time can thereby be reduced.

A database consistency checker tool 412 may be integrated with the migration tool 410. (Although depicted as part of the migration tool 410, the consistency checker tool 412 may, alternatively, be a separate module in communication with the migration tool 410.) The consistency checker tool 412 may utilize some of the functionality already provided by the migration tool 410 for the purpose of managing the migration, such as the ability to read in portions of data and determine their key ranges (as provided, in the tool 100 described with respect to FIG. 1, by database interface module 102), or the ability to covert data to a new format (e.g., ABAP) as may be utilized by the software application version 402b accessing and/or operating on the data. In some embodiments, the system 400 includes multiple consistency checker tools 412 that can operate in parallel. Alternatively, a consistency checker tool 412 may spawn off multiple consistency-checking processes. Again, such parallelization may utilize any already existing capability of the migration tool 410 to split up databases into multiple tables or portions for parallel transfer.

The different components involved in database migration and software updates/upgrades may be hosted on one or more computer systems. In some embodiments, an application server that hosts the software application (in both versions 402a and 402b) accesses databases 404, 406 that are stored on a separate host (or hosts) remotely via a network (e.g., the Internet). In other embodiments, a single server may originally host both the software application versions 402a, 402b and the database 404, but migration to the new database 406 may be combined with an upgrade of the hardware on which the database runs, such that the upgraded version 402b and the new database 406 are ultimately hosted on different servers in communication via a network. Conversely, if the software application versions 402a, 402b are hosted separately from the old database 404, the data may be migrated to a new database 406 stored on the same server as the application version 402b. In yet other embodiments, entirely new software (rather than merely an upgrade of the old software), installed on a new host system, is taken into production, and the database is transferred to that new host system.

### Modules, Components, and Logic

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or with any suitable combination thereof. For example, a hardware module may include dedicated circuitry or logic that is permanently configured to perform certain operations. For example, a hardware module may be a special-purpose processor, such as a field-programmable gate array (FPGA) or an Application Specific Integrated Circuit (ASIC). A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Software Architecture

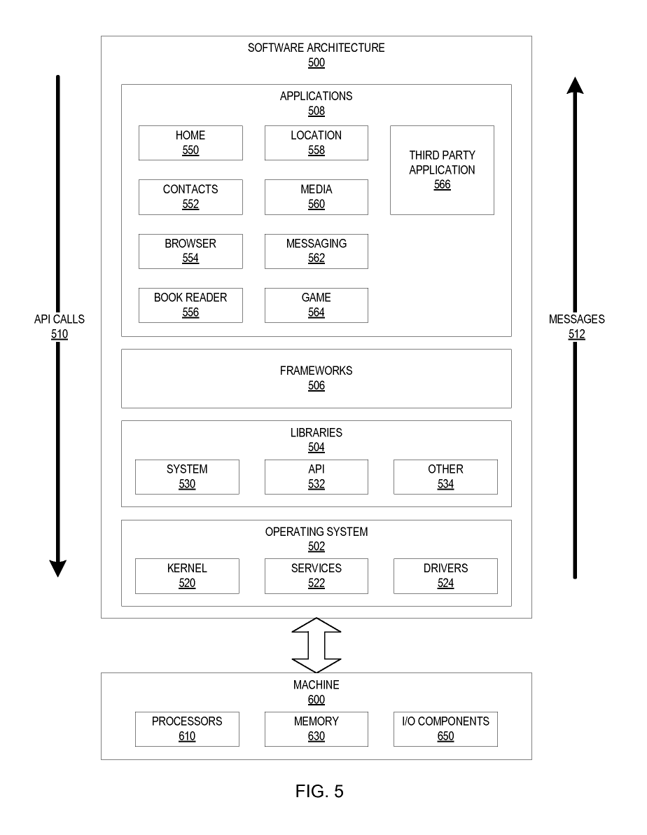

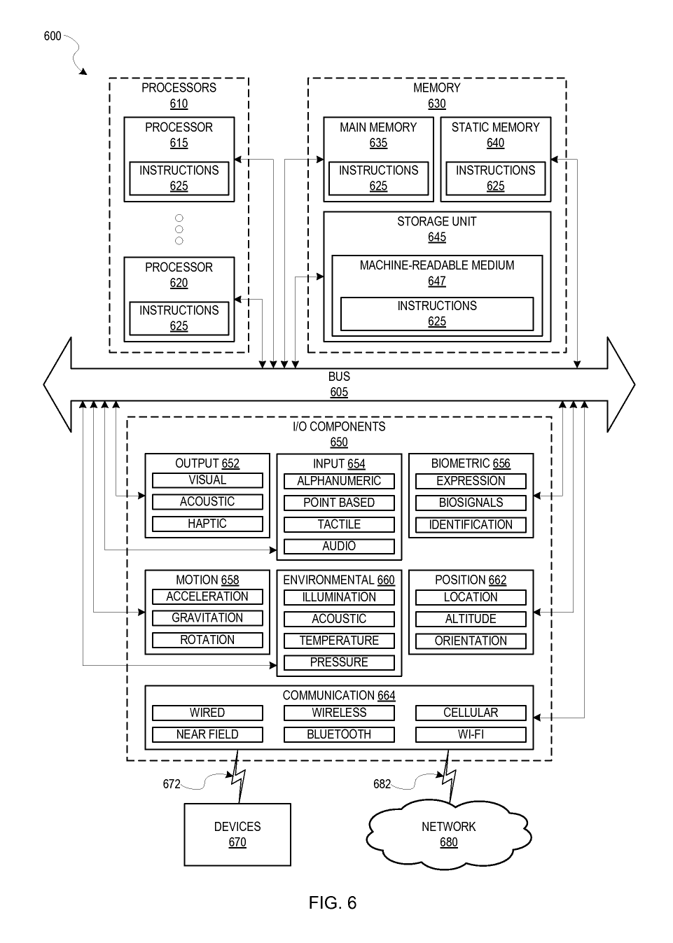

FIG. 5 is a block diagram illustrating an architecture of software 500 implementing the methods described herein. FIG. 5 is merely a non-limiting example of a software architecture and it will be appreciated that many other architectures may be implemented to facilitate the functionality described herein. The software 500 may be executing on hardware such as a machine 600 of FIG. 6 that includes processors 610, memory 630, and I/O components 650. In the example architecture of FIG. 5, the software 500 may be conceptualized as a stack of layers where each layer may provide particular functionality. For example, the software 500 may include layers such as an operating system 502, libraries 504, frameworks 506, and applications 508. Operationally, the applications 508 may invoke application programming interface (API) calls 510 through the software stack and receive messages 512 in response to the API calls 510.

The operating system 502 may manage hardware resources and provide common services. The operating system 502 may include, for example, a kernel 520, services 522, and drivers 524. The kernel 520 may act as an abstraction layer between the hardware and the other software layers. For example, the kernel 520 may be responsible for memory management, processor management (e.g., scheduling), component management, networking, security settings, and so on. The services 522 may provide other common services for the other software layers. The drivers 524 may be responsible for controlling and/or interfacing with the underlying hardware. For instance, the drivers 524 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 504 may provide a low-level common infrastructure that may be utilized by the applications 508. The libraries 504 may include system libraries 530 (e.g., C standard library) that may provide functions such as memory allocation functions, string manipulation functions, mathematic functions, and the like. In addition, the libraries 504 may include API libraries 532 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 504 may also include a wide variety of other libraries 534 to provide many other APIs to the applications 508.

The frameworks 506 may provide a high-level common infrastructure that may be utilized by the applications 508. For example, the frameworks 506 may provide various graphic user interface (GUI) functions, high-level resource management, high-level location services, and so forth. The frameworks 506 may provide a broad spectrum of other APIs that may be utilized by the applications 508, some of which may be specific to a particular operating system or platform.

The applications 508 may include a home application 550, a contacts application 552, a browser application 554, a book reader application 556, a location application 558, a media application 560, a messaging application 562, a game application 564, and a broad assortment of other applications such as a third-party application 566. In a specific example, the third-party application 566 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 566 may invoke the API calls 510 provided by the operating system to facilitate functionality described herein.

### Example Machine Architecture and Machine-Readable Medium

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system, within which instructions 625 (e.g., software, a program, an application, an applet, an app, or other executable code) for causing the machine 600 to perform any one or more of the methodologies discussed herein may be executed. In alternative embodiments, the machine 600 operates as a standalone device or may be coupled (e.g., networked) to other machines. In a networked deployment, the machine 600 may operate in the capacity of a server machine or a client machine in a server-client network environment, or as a peer machine in a peer-to-peer (or distributed) network environment. The machine 600 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 625, sequentially or otherwise, that specify actions to be taken by the machine 600. Further, while only a single machine 600 is illustrated, the term “machine” shall also be taken to include a collection of machines 600 that individually or jointly execute the instructions 625 to perform any one or more of the methodologies discussed herein.

The machine 600 may include processors 610, memory 630, and I/O components 650, which may be configured to communicate with each other via a bus 605. In an example embodiment, the processors 610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 615 and a processor 620 that may execute the instructions 625. The term “processor” is intended to include multi-core processor that may comprise two or more independent processors (also referred to as “cores”) that may execute instructions contemporaneously. Although FIG. 6 shows multiple processors 610, the machine 600 may include a single processor with a single core, a single processor with multiple cores (e.g., a multi-core processor), multiple processors with a single core, multiple processors with multiples cores, or any combination thereof.

The memory 630 may include a main memory 635, a static memory 640, and a storage unit 645 accessible to the processors 610 via the bus 605. The storage unit 645 may include a machine-readable medium 647 on which is stored the instructions 625 embodying any one or more of the methodologies or functions described herein. The instructions 625 may also reside, completely or at least partially, within the main memory 635, within the static memory 640, within at least one of the processors 610 (e.g., within a processor's cache memory), or any suitable combination thereof, during execution thereof by the machine 600. Accordingly, the main memory 635, the static memory 640, and the processors 610 may be considered machine-readable media 647.

As used herein, the term “memory” refers to a machine-readable medium 647 able to store data temporarily or permanently, and may be taken to include, but not be limited to, random-access memory (RAM), read-only memory (ROM), buffer memory, flash memory, and cache memory. While the machine-readable medium 647 is shown in an example embodiment to be a single medium, the term “machine-readable medium” should be taken to include a single medium or multiple media (e.g., a centralized or distributed database, or associated caches and servers) able to store the instructions 625. The term “machine-readable medium” shall also be taken to include any medium, or combination of multiple media, that is capable of storing instructions (e.g., instructions 625) for execution by a machine (e.g., machine 600), such that the instructions, when executed by one or more processors of the machine 600 (e.g., processors 610), cause the machine 600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 650 may include a wide variety of components to receive input, provide and/or produce output, transmit information, exchange information, capture measurements, and so on. It will be appreciated that the I/O components 650 may include many other components that are not shown in FIG. 6. In various example embodiments, the I/O components 650 may include output components 652 and/or input components 654. The output components 652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 654 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, and/or other pointing instruments), tactile input components (e.g., a physical button, a touch screen that provides location and force of touches or touch gestures, and/or other tactile input components), audio input components (e.g., a microphone), and the like.

In further example embodiments, the I/O components 650 may include biometric components 656, motion components 658, environmental components 660, and/or position components 662 among a wide array of other components. For example, the biometric components 656 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 658 may include acceleration sensor components (e.g., accelerometer), gravitation sensor components, rotation sensor components (e.g., gyroscope), and so forth. The environmental components 660 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), and/or other components that may provide indications, measurements, and/or signals corresponding to a surrounding physical environment. The position components 662 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 650 may include communication components 664 operable to couple the machine 600 to a network 680 and/or devices 670 via coupling 682 and coupling 672 respectively. For example, the communication components 664 may include a network interface component or other suitable device to interface with the network 680. In further examples, communication components 664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 670 may be another machine and/or any of a wide variety of peripheral devices (e.g., a peripheral device coupled via a Universal Serial Bus (USB)).

Moreover, the communication components 664 may detect identifiers and/or include components operable to detect identifiers. For example, the communication components 664 may include Radio Frequency Identification (RFID) tag reader components, NFC smart tag detection components, optical reader components (e.g., an optical sensor to detect one-dimensional bar codes such as Universal Product Code (UPC) bar codes, multi-dimensional bar codes such as Quick Response (QR) codes, Aztec codes, Data Matrix, Dataglyph, MaxiCode, PDF417, Ultra Code, UCC RSS-2D bar codes, and other optical codes), acoustic detection components (e.g., microphones to identify tagged audio signals), and so on. In additional, a variety of information may be derived via the communication components 664, such as location via Internet Protocol (IP) geo-location, location via Wi-Fi® signal triangulation, location via detecting an NFC beacon signal that may indicate a particular location, and so forth.

### Transmission Medium

In various example embodiments, one or more portions of the network 680 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 680 or a portion of the network 680 may include a wireless or cellular network and the coupling 682 may be a Code Division Multiple Access (CDMA) connection, a Global System for Mobile communications (GSM) connection, or another type of cellular or wireless coupling. In this example, the coupling 682 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 625 may be transmitted and/or received over the network 680 using a transmission medium via a network interface device (e.g., a network interface component included in the communication components 664) and utilizing any one of a number of well-known transfer protocols (e.g., hypertext transfer protocol (HTTP)). Similarly, the instructions 625 may be transmitted and/or received using a transmission medium via the coupling 672 (e.g., a peer-to-peer coupling) to the devices 670. The term “transmission medium” shall be taken to include any intangible medium that is capable of storing, encoding, or carrying instructions 625 for execution by the machine 600, and includes digital or analog communications signals or other intangible media to facilitate communication of such software.

Furthermore, the machine-readable medium 647 is non-transitory (in other words, not having any transitory signals) in that it does not embody a propagating signal. However, labeling the machine-readable medium 647 “non-transitory” should not be construed to mean that the medium is incapable of movement; the medium should be considered as being transportable from one physical location to another. Additionally, since the machine-readable medium 647 is tangible, the medium 647 may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within the scope of embodiments of the present disclosure as represented by the appended claims. The specification and drawings are, accordingly, to be regarded in an illustrative rather than a restrictive sense.

What is claimed is:

1. A system comprising:
a plurality of modules forming part of one or more hardware processor arrangements, the modules comprising:
a database interface module configured to read in data from a first database and from a second database, the second database resulting from migration of the first database;
a checksum module configured to compute checksums for each of a plurality of portions of the first database and for each of a corresponding plurality of portions of the second database;
a comparison module configured to compare pairs of checksums computed for corresponding portions of the first and second databases and to detect any discrepancies between the checksums of the pairs; and
a control module configured to cause the checksum module and the comparison module to repeat the checksum computation and comparison for sub-portions of two corresponding portions of the first and second databases upon detection of a discrepancy between the checksums for those two corresponding portions.

2. The system of claim 1, wherein the control module is configured to cause the checksum module and the comparison module to repeat the checksum computation and comparison iteratively for increasingly smaller sub-portions until an origin of the discrepancy is localized in corresponding minimal-size sub-portions of the first and second databases.

3. The system of claim 1, wherein the portions of the first database are determined based on a specified number of database entries.

4. The system of claim 3, wherein the portions of the second database are determined based the specified number of database entries.

5. The system of claim 3, wherein the portions of the second database are determined based on key ranges associated with the portions of the first database.

6. The system of claim 3, wherein the sub-portions are determined based on a specified fraction of the specified number of database entries.

7. The system of claim 3, wherein the control module is configured to determine the specified number of database entries based at least in part on a size of the first database.

8. The system of claim 1, wherein the checksum module is configured to save the checksums for the first database in at least one first file and the checksums for the second database in at least one second file, and wherein the comparison module is configured to read checksums from the at least one first file and the at least one second file.

9. The system of claim 1, wherein the database interface module is further configured to convert the data from the first database and the data from the second database into a common format.

10. A method comprising, using a computer:
dividing a first database into a plurality of portions and computing checksums for the plurality of portions;
dividing a second database that results from migration of the first database into a plurality of portions corresponding to the plurality of portions of the first database, and computing checksums for the plurality of portions of the second database;
comparing pairs of checksums computed for corresponding portions of the first and second databases and detecting any discrepancies between the checksums of the pairs; and
upon detection of a discrepancy between the checksums computed for two corresponding portions of the first and second databases, subdividing the corresponding portions into corresponding sub-portions, computing checksums for the sub-portions, and comparing pairs of checksums computed for corresponding sub-portions to detect any discrepancies therebetween.

11. The method of claim 10, further comprising writing the checksums computed for the portions of the first database to at least one first file and writing the checksums computed for the portions of the second database to at least one second file.

12. The method of claim 11, further comprising counting entries in the portions of the first and second databases and writing the entry counts along with the checksums to the at least one first file and the at least one second file, respectively.

13. The method of claim 12, further comprising determining end keys of the portions of the first database and writing the end keys along with the checksums to the at least one first file.

14. The method of claim 13, further comprising determining the portions of the second database based on the end keys of the portions of the first database.

15. The method of claim 10, comprising iteratively repeating, for increasingly smaller sub-portions, the subdivision into sub-portions, the computation of checksums for the sub-portions and the comparison of pairs of checksums, until a size of the sub-portions corresponds to a single database entry.

16. The method of claim 10, wherein each of the plurality of portions, except a last portion of the plurality, comprises a specified number of database entries.

17. The method of claim 16, wherein each of the plurality of sub-portions, except a last sub-portion, comprises a specified fraction of the specified number of database entries.

18. A system comprising:
a plurality of modules forming part of one or more hardware processor arrangements, the modules comprising:
a database migration tool configured to read in data from a first database and write the data to a second database; and
a database consistency checker tool configured to compute checksums for each of a plurality of portions of the first database and for each of a corresponding plurality of portions of the second database, to compare pairs of checksums computed for corresponding portions of the first and second databases, to detect any discrepancies between the checksums of the pairs, and to repeat the checksum computation and comparison for sub-portions of two corresponding portions of the first and second databases upon detection of a discrepancy between the checksums for those two corresponding portions.

19. The system of claim 18, wherein the plurality of modules further comprises:
a software upgrade tool configured to upgrade a software application from an old version accessing the first database to a new version accessing the second database.

20. The system of claim 18, wherein the first database is stored on a first host and the second database is stored on a second host different from the first host.
